(19) United States
(12) Patent Application Publication
(10) Pub. No.: US 2016/0194988 A1
(43) Pub. Date: Jul. 7, 2016

(54) HOUSING FOR A CRANKCASE VENTILATION SYSTEM

(71) Applicant: Caterpillar Inc., Peoria, IL (US)

(72) Inventors: Rodney Allen Lawrence, Frankfort, IN (US); Brandyn Anthony Stack, Lafayatte, IN (US); Eric William Ferguson, Cottage Grove, MN (US)

(73) Assignee: Caterpillar Inc., Peoria, IL (US)

(21) Appl. No.: 15/067,201

(22) Filed: Mar. 11, 2016

(51) Int. Cl. F01M 13/04; F02M 25/06

(52) U.S. Cl. CPC F01M 13/0416; F02M 25/06; F01M 2013/0472

(57) ABSTRACT

A housing for a crankcase ventilation system of an engine is provided. The housing includes a plurality of walls connected together and having an outer surface and an inner surface. The inner surface of the plurality of walls defines a central cavity therewithin. The central cavity is adapted to enclose at least a portion of each of a Valve Cover integrated Breather (VCIB), an oil mist separator, and an inlet line connecting the VCIB and the oil mist separator. The housing also includes a coupling mechanism provided on one of the plurality of walls to mount the housing to the engine.

### TECHNICAL FIELD

The present disclosure relates to a crankcase ventilation system for an engine. More specifically, the present disclosure relates to a housing for the crankcase ventilation system of the engine.

### BACKGROUND

Internal combustion engines typically employ crankcase ventilation (CV) systems to provide ventilation of blow-by gases generated during combustion process from the crankcase to a turbocharger and/or to atmosphere. Components of the crankcase ventilation system may generally be directly or indirectly exposed to atmosphere and as such may be susceptible to direct impact of prevailing weather conditions such as ambient temperature.

In cold weather conditions, the CV system may be susceptible to heat loss to the atmosphere. In such a situation, if the blow-by gases are overcooled, the water vapor entrained in the blow-by gases may condense. This condensed water vapor may further mix with oil and generate an oil-water emulsion. Additionally, if further cooled, the condensed vapor and/or the oil-water emulsion may freeze. This may result in a failure mode by restricting flow of blow-by gases within the crankcase ventilation system, in turn causing high pressure within the crankcase ventilation system. Also emulsion and freezing can cause high pressure within the crankcase of the engine. The CV system is intended to maintain crankcase pressure within allowable limits, otherwise it may lead to crankcase failure.

U.S. Pat. No. 7,537,000 describes an engine with a breather apparatus introducing a blow-by gas to an intake passage of the engine via a blow-by gas passage. The apparatus includes a breather heater provided within a breather tube of a blow-by gas passage corresponding to an external portion of the engine. The breather tube has a slot formed by passing through a wall portion of the breather tube. The breather heater is incorporated into the breather tube by passing through the slot from outside of the breather tube so as to protrude into a blow-by gas passing cavity formed within the breather tube. The breather heater is provided with a heater case formed of a thermally conductive material accommodating a heating element and one end of a heat radiating body is joined to the heater case. The engine is provided with a tubular heat insulator covering at least the slot in an outer periphery of the breather tube.

However, addition of insulation or heating means to selected individual components of the crankcase ventilation system may be traditionally costly, require frequent maintenance, and have sub-optimal operational performance. Hence, there is a need for an improved insulation means for the CV system.

### SUMMARY OF THE DISCLOSURE

In an aspect of the present disclosure, a housing for a crankcase ventilation system of an engine is provided. The housing includes a plurality of walls connected together and having an outer surface and an inner surface. The inner surface of the plurality of walls defines a central cavity therewithin. The central cavity is adapted to enclose at least a portion of each of a Valve Cover Integrated Breather (VCIB), an oil mist separator, and an inlet line connecting the VCIB and the oil mist separator. The housing also includes a coupling mechanism provided on one of the plurality of walls to mount the housing to the engine.

Other features and aspects of this disclosure will be apparent from the following description and the accompanying drawings.

### BRIEF DESCRIPTION OF THE DRAWINGS

FIG. 1 is a perspective view of an engine having a housing mounted on a Crankcase Ventilation (CV) system in accordance with one embodiment of the present disclosure;

FIG. 2 is a perspective exploded view of the housing of FIG. 1 from the CV system in accordance with one embodiment of the present disclosure;

FIG. 3 is a perspective view of the housing of FIG. 1 in accordance with one embodiment of the present disclosure; and

FIG. 4 is another perspective view of the housing of FIG. 1 in accordance with one embodiment of the present disclosure.

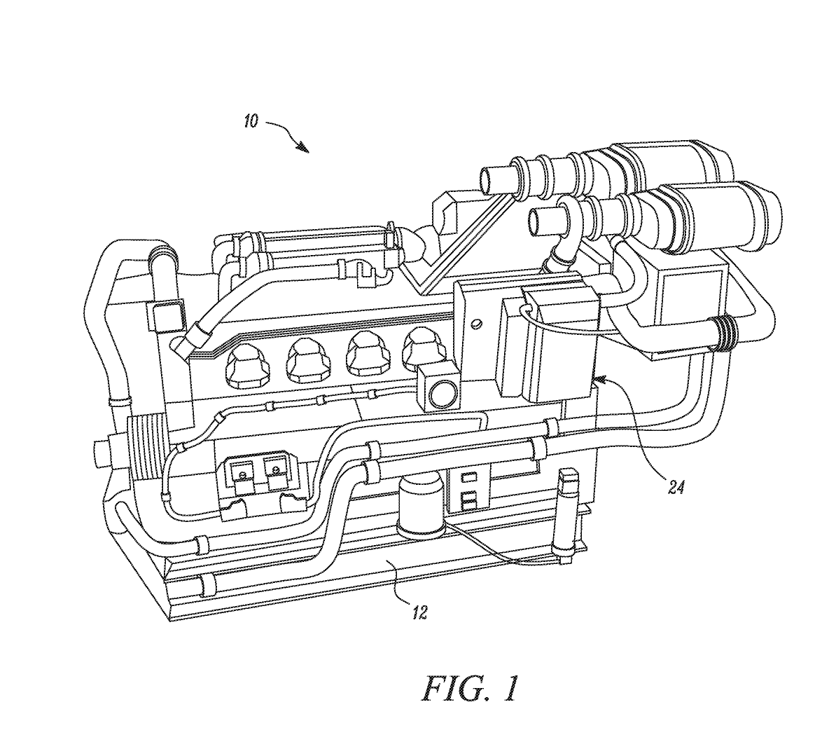

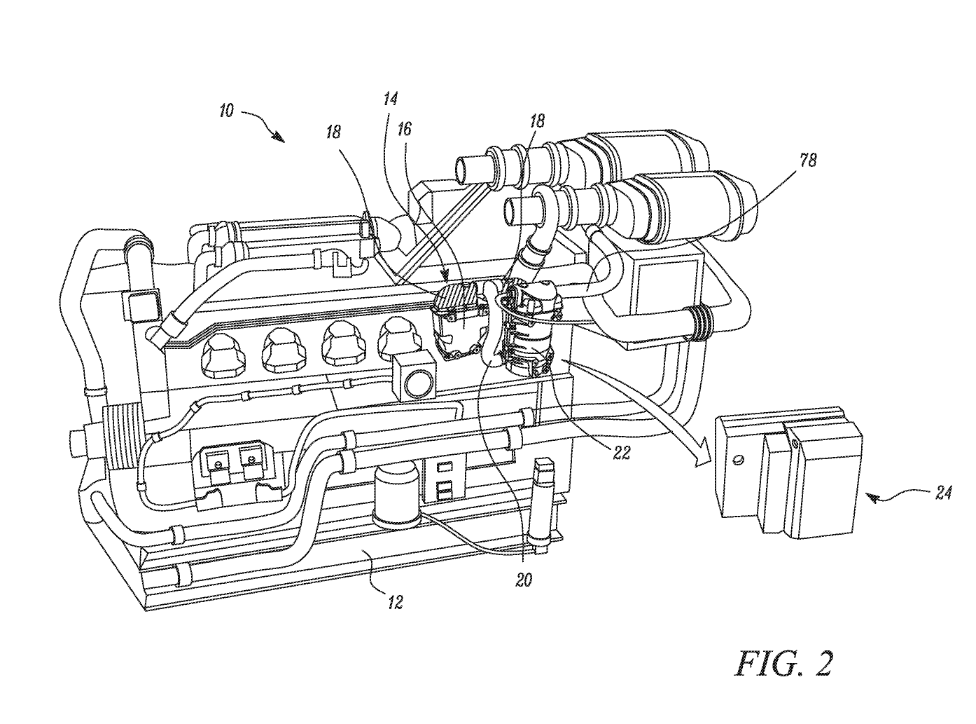

### DETAILED DESCRIPTION

Wherever possible, the same reference numbers will be used throughout the drawings to refer to the same or the like parts. Referring to FIGS. 1 and 2, an exemplary engine 10 is illustrated. The engine 10 may be any internal combustion engine powered by any fuel known in the art such as gasoline, diesel, natural gas, and so on, or a combination thereof. The engine 10 may be used for applications including, but not limited to, power generation, transportation, construction, agriculture, forestry, aviation, marine, material handling, and waste management.

The engine 10 includes a frame 12. The frame 12 is configured to support various components of the engine 10 such as an engine block, a crankcase, a cylinder head, a fuel system, an air system, a cooling system, a turbocharger, an exhaust gas recirculation system, an exhaust aftertreatment system, other peripheries, and so on. Also, the engine 10 may be of any size including one or more cylinders arranged in any configuration such as inline, radial, “V”, and so on.

Referring to FIG. 2, the engine 10 also includes a Crankcase Ventilation (CV) System 14. The CV system 14 is configured to vent blow-by gases trapped within the crankcase of the engine 10. The CV system 14 includes a Valve Cover Integrated Breather (VCIB) 16. The VCIB 16 is configured to receive the blow-by gases from the crankcase and provide partial filtration of oil present in the blow-by gases. The CV system includes one or more heaters 18 affixed to the VCIB 16. The heater 18 is configured to heat the blow-by gases present within the VCIB 16. The heater 18 is a silicone type heater but may include any other type, but not limited to, a coil type heater and a plate type heater. The heater 18 may be affixed to the VCIB 16 by a vulcanization process. In other embodiments, the heater 18 may be affixed to the VCIB 16 by any other fastening means such as adhesion, bolting, riveting, welding, and so on.

The CV system also includes an inlet line 20 fluidly connected between the VCIB 16 and an oil mist separator 22. The inlet line 20 is configured to provide a fluid passage to the partially filtered oil from the VCIB 16 to the oil mist separator 22. The CV system includes the oil mist separator 22 affixed to the VCIB 16. The oil mist separator 22 is affixed to the VCIB 16 by any known fastening means such as bolting, riveting, welding, and so on. The oil mist separator 22 is configured to provide further filtration of the partially filtered oil received from the VCIB 16.

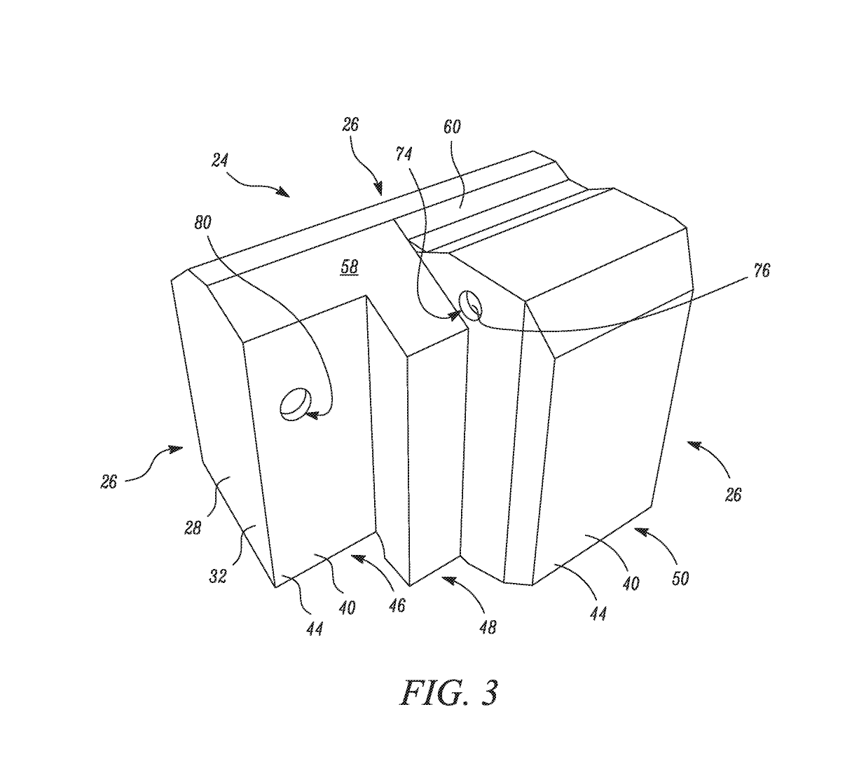

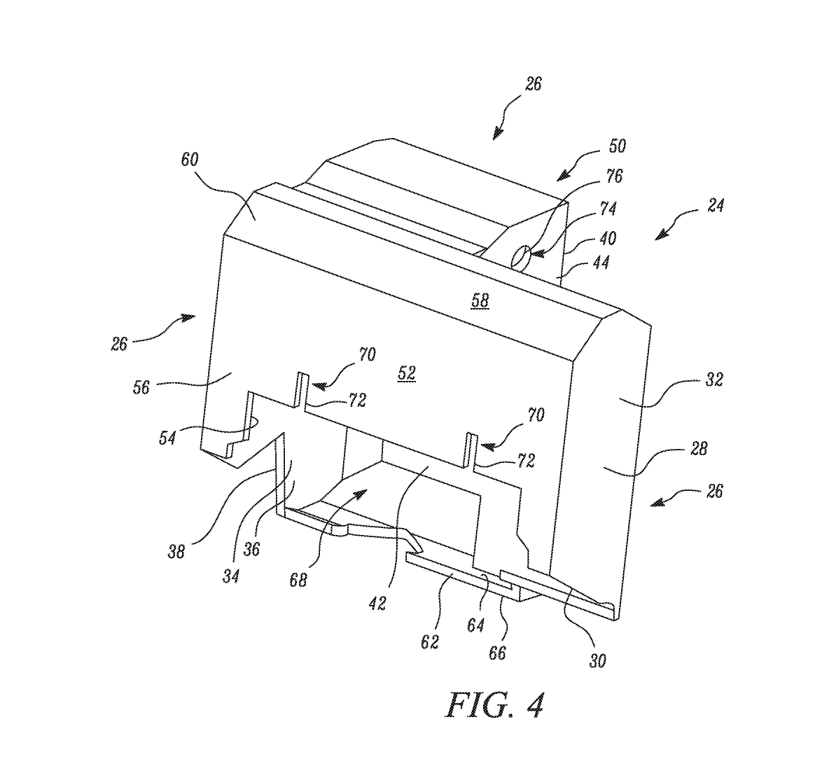

Referring to FIGS. 1 and 2, the present disclosure relates to a housing 24 for the CV system. When assembled, the housing 24 is configured to enclose at least a portion of the multiple components of the CV system 14, including the VCIB 16, the oil mist separator 22, and the inlet line 20. Accordingly, the housing 24 is configured to insulate the multiple components of the CV system 14. Further, the housing 24 is made of low thermal conductivity material to minimize heat transfer. The structure and shape of the housing 24 will be explained in detail in connection with FIGS. 3 and 4.

Referring to FIGS. 3 and 4, the housing 24 includes a number of walls 26 interconnected with each other. More specifically, the housing 24 includes a first wall 28. The first wall 28 has a flat and planar configuration defining an inner surface 30 and an outer surface 32. The housing 24 also includes a second wall 34. The second wall 34 has a flat and planar configuration defining an inner surface 36 and an outer surface 38. In other embodiments, the first and second walls 28, 34 may have a different shape based on application requirements and does not limit the scope of the disclosure. The first and second walls 28, 34 are disposed spaced apart and parallel to one another. In other embodiments, the first and second walls 28, 34 may be disposed at any angle with respect to one another.

The housing 24 also includes a third wall 40. The third wall 40 includes an inner surface 42 and an outer surface 44. The third wall 40 is disposed substantially perpendicular to the first and second walls 28, 34. In other embodiments, the third wall 40 may be disposed at any angle with respect to the first and second walls 28, 34.

The third wall 40 has a stepped configuration defining a first stepped portion 46, a second stepped portion 48, and a third stepped portion 50. In other embodiments, the third wall 40 may include any number of stepped portions. The first, second, and third stepped portions 46, 48, 50 are configured to enclose various components of the CV system 14 and will be explained later in more detail.

The housing 24 includes a fourth wall 52. The fourth wall 52 has a flat and planar configuration defining an inner surface 54 and an outer surface 56. In other embodiments, the shape and dimensions of the fourth wall 52 may vary. The third and fourth walls 40, 52 are disposed spaced apart and substantially parallel to one another. Also, the fourth wall 52 is disposed substantially perpendicular to the first and/or second walls 28, 34. In other embodiments, the third and fourth walls 40, 52 may be disposed at any angle with respect to one another and/or the first and second walls 28, 34. It should be noted that an orientation of the third and fourth walls 40, 52 with respect to one another and/or the first and second walls 28, 34 illustrated herein is merely exemplary and does not limit the scope of the disclosure.

The housing 24 also includes a top wall 58. The top wall 58 includes an angular configuration defining an inner surface (not shown) and an outer surface 60. The top wall 58 is disposed in a manner such that each of the first wall 28, the second wall 34, the third wall 40, and the fourth wall 52 are in connection with the top wall 58. The housing 24 further includes a bottom wall 62. The bottom wall 62 has an angular configuration defining an inner surface 64 and an outer surface 66. The bottom wall 62 is disposed in a manner such that each of the first wall 28, the second wall 34, the third wall 40, and the fourth wall 52 are in connection with the bottom wall 62.

The inner surface 30 of the first wall 28, the inner surface 36 of the second wall 34, the inner surface 42 of the third wall 40, the inner surface 54 of the fourth wall 52, the inner surface of the top wall 58, and the inner surface 64 of the bottom wall 62 defines a hollow, central cavity 68. The central cavity 68 is configured to enclose at least a portion of the CV system therewithin. The shape of the housing 24 is such that the multiple components of the CV system, including the VCIB 16, the oil mist separator 22, and the inlet line 20 are received therewithin. The housing 24 is configured to insulate the multiple components of the CV system.

Referring to FIGS. 2, 3 and 4, the first stepped portion 46 of the third wall 40 is shaped and disposed on the third wall 40 corresponding to a location of the VCIB 16 and the heater 18. As such, the first stepped portion 46 is configured to enclose a portion of the VCIB 16 and the heater 18 therein. The second stepped portion 48 of the third wall 40 is shaped and disposed on the third wall 40 corresponding to a location of the inlet line 20. As such, the second stepped portion 48 is configured to enclose a portion of the inlet line 20 therein. The third stepped portion 50 of the third wall 40 is shaped and disposed on the third wall 40 corresponding to a location of the oil mist separator 22. As such, the third stepped portion 50 is configured to enclose a portion of the oil mist separator 22 therein.

Referring to FIG. 4, the fourth wall 52 of the housing 24 includes a coupling mechanism 70 to couple the housing 24 on the engine 10. The coupling mechanism 70 includes slots 72 provided thereon. The slots 72 are configured to engage with a mounting member (not shown) provided on the engine 10 to mount the housing 24 onto the engine 10. In one embodiment, the slots 72 may fit into one or more flanges provided on a body of the VCIB 16. The mounting member may include a bolt, a screw, a bracket, any protruding element, and so on provided on the engine 10. In other embodiments, the coupling mechanism 70 may include bolts, screws, straps, and so on for directly affixing any of the walls 26 of the housing 24 to the engine 10. Alternatively, the housing 24 may be mounted to the engine 10 by any method known in the art such as bolting, strapping, and so on.

As shown in FIGS. 3 and 4, the housing 24 includes one or more cutouts 74 provided for receiving components such as an inlet, an outlet, tubing, and so on of the CV system 14. For example, the third wall 40 includes a first cutout 76 and a second cutout (not shown) provided on the third stepped portion 50 thereof. The first cutout 76 and the second cutout are provided to receive an a boost air inlet 78 (see FIG. 2) and an outlet (not shown) respectively of the oil mist separator 22. Similarly, additional cutouts 80 (see FIG. 3) may be provided on any of the walls 26 of the housing 24 for providing maintenance access and/or access to other components of the system based on application requirements.

Each of the walls 26 including the first wall 28, the second wall 34, the third wall 40, the fourth wall 52, the top wall 58, and the bottom wall 62 are connected to one another by any known method such as adhesion, sewing, bolting, stapling, riveting, and so on. In other embodiments, the housing 24 may be formed as a single integral component by additive manufacturing process, casting, molding, and so on. The housing 24 may be made of any material known in the art including, but not limited to, TEFLON, fiber glass, glass wool, foam, polystyrene, and other polymers. A person of ordinary skill in the art will appreciate that the description of the housing 24 provided herein does not limit the scope of the present disclosure. The shape and dimensions of the housing 24 may vary based on that of the CV system 14.

### INDUSTRIAL APPLICABILITY

The present disclosure relates to the housing 24 for the components of the CV system 14. More specifically, the housing 24 is configured to insulate the CV system 14 including the VCIB 16, the heater 18, the inlet line 20, and the oil mist separator 22 from low ambient temperatures. Moreover, the housing 24 also traps heat rejection from cylinder heads of the engine 10. As a result, freezing of water vapor and/or oil-water emulsion present within the CV system 14 may be minimized or prevented. Also, the housing 24 may be positioned in such a manner over core engine components, that the housing 24 may entrap heat generated by the heater 18 and/or other engine components around the CV system 14 within the housing 24. This may minimize or reduce undesired heat loss to atmosphere and improve efficiency of the heater 18 and/or the CV system 14.

Further, the heater 18 located within the housing 24 may further minimize heat loss, and in some cases, during operation, may heat the blow-by gas within the CV system 14. In one example, the heater 18 includes an electrical resistive heater which when vulcanized to the components of the CV system 14 made of aluminum may prove to be very effective. In one situation, the housing 24 may ensure that a temperature of the multiple components of the CV system 14 enclosed therewithin remains above the dew point temperature of the blow-by gas during operation of the engine 10 in cold ambient temperatures. Further, in another situation, the heater 18 used together with the housing 24 may ensure that the temperature of the multiple components of the CV system 14 enclosed therewithin remains above the dew point temperature of the blow-by gas during operation of the engine 10 in cold ambient temperatures.

Additionally, an overall shape of the housing 24 is configured to provide a tailor-made enclosure for the CV system 14 such that the housing 24 may be modified to receive any arrangement of the CV system 14 therewithin. As such, the housing 24 may include angled surfaces, chamfered/beveled edges, depressions/contours on surfaces, cutouts, stepped portions and so on to conform the central cavity 68 to an overall shape of the CV system 14. As a result, the housing 24 may provide a minimum footprint around the CV system 14 while still providing a maximum enclosure area, resulting in a cost efficient and a space efficient design of the housing 24.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of the disclosure. Such embodiments should be understood to fall within the scope of the present disclosure as determined based upon the claims and any equivalents thereof.

What is claimed is:

1. A housing for a crankcase ventilation (CV) system of an engine, the housing comprising:
a plurality of walls connected together and having an outer surface and an inner surface, wherein the inner surface of the plurality of walls defines a central cavity therewithin, and wherein the central cavity is adapted to enclose at least a portion of each of a Valve Cover Integrated Breather (VCIB), an oil mist separator, and an inlet line connecting the VCIB and the oil mist separator; and
a coupling mechanism provided on one of the plurality of walls to mount the housing to the engine.

2. The housing for the CV system of claim 1, wherein the plurality of walls encloses a heating element coupled to a valve cover of the engine.
